(19) United States
(12) Patent Application Publication
(10) Pub. No.: US 2007/0083666 A1
(43) Pub. Date: Apr. 12, 2007

(54) Bandwidth management of multimedia transmission over networks

(75) Inventor: Jacob Apelbaum, Sayville, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/250,184

(22) Filed: Oct. 12, 2005

(51) Int. Cl. G06F 15/16

(52) U.S. Cl. 709/231; 709/204

(57) ABSTRACT

Methods and systems are provided for managing bandwidth in transmitting multimedia over a network. An audio stream is created from transmission of audio information over the network at an audio rate. A video stream is created for transmission of video information over the network at a video rate. A data stream is created for transmission of data information over the network at a data rate. Each of the audio rate, the video rate, and the data rate is determined independently of others and they are collectively transmitted according to a priority hierarchy that gives precedence of the audio stream over the video stream and data stream, and gives precedence of the data stream over the video stream.

### CROSS REFERENCE TO RELATED APPLICATIONS

This application is related to the following commonly assigned, concurrently filed applications, each of which is incorporated herein by reference in its entirety for all purposes: U.S. Pat. Appl. No.______, entitled “VIDEO CONFERENCING SYSTEMS AND METHODS,” filed by Jacob Apelbaum (Attorney Docket No. 20375-066000US) and U.S. Pat. Appl. No.______, entitled “MANAGEMENT OF VIDEO TRANSMISSION OVER NETWORKS,” filed by Jacob Apelbaum (Attorney Docket No. 20375-067700US).

### BACKGROUND OF THE INVENTION

This application relates to video conferencing systems and methods.

Effective collaboration in business and other environments has long been recognized as being of considerable importance. This is particularly true for the development of new ideas as interactions fostered by the collaboration may be highly productive in expanding those ideas and generating new avenues for thought. As business and other activities have become more geographically disperse, efforts to provide collaborative environments have relied on travel by individuals so that they may collaborate in person or have relied on telecommunications conferencing mechanisms.

Travel by individuals to participate in a conference may be very costly and highly inconvenient to the participants. Despite this significant drawback, it has long been, and still is, the case that in-person collaboration is viewed as much more effective than the use of telecommunications conferencing. Telephone conferences, for example, provide only a limited form of interaction among the participants, does not easily permit side conversations to take place, and is generally a poor environment for working collaboratively with documents and other visual displays. Some of these drawbacks are mitigated with video conferencing in which participants may see and hear other, but there are still weaknesses in these types of environments as they are currently implemented.

There is accordingly a general need in the art for improved conferencing capabilities that provides for high interactivity among conference participants.

### BRIEF SUMMARY OF THE INVENTION

Embodiments of the invention provide methods and systems for managing bandwidth in transmitting multimedia over a network. An audio stream is created from transmission of audio information over the network at an audio rate. A video stream is created for transmission of video information over the network at a video rate. A data stream is created for transmission of data information over the network at a data rate. Each of the audio rate, the video rate, and the data rate is determined independently of others of the audio rate, the video rate, and the data rate. The audio stream, the video stream, and the data stream are collectively transmitted over the network and respectively at the audio rate, the video rate, and the data rate according to a priority hierarchy that gives precedence of the audio stream over the video stream and data stream, and gives precedence of the data stream over the video stream.

A bandwidth may be assigned for the video stream and data stream substantially equal to a total bandwidth for the network less a bandwidth used by the audio stream corresponding to the audio rate. A current average size of the data stream may be determined. A bandwidth for the video stream may be assigned equal to the bandwidth for the video stream and data stream less the current average size of the data stream. The video rate is then determined from the assigned bandwidth for the video stream. In some instances, the resulting assigned bandwidth for the video stream may be approximately zero, in which case the data stream and the video stream may compete for transmission over the network.

A specification may be received of a network-connection type to define the total bandwidth. Examples of network-connection types includes a 28.8 kbps modem connection, a 56.6 kbps modem connection, a cable connection, a digital subscriber line (“DSL”), an integrated services digital network (“ISDN”) connection, a satellite link, and a local-area-network (“LAN”) connection. The data stream may comprise whiteboard information, may comprise instant-messaging information, or may comprise program-sharing information in certain specific embodiments.

The above methods may also be embodied in a system that comprises an audio subsystem, a video system, a data subsystem, respectively configured to create the audio, video, and data streams. A communications system is interfaced with the audio, video, and data subsystems and configured to transmit the audio, video, and data streams. A controller may be provided in communication with the audio, video, and data subsystems to implement aspects of the methods described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 is a flow diagram summarizing multiple capabilities that may be provided with a conferencing application in an embodiment of the invention;

FIG. 2A as a flow diagram that summarizes aspects of video and audio conferencing within the conferencing application;

FIG. 2B is an exemplary screen view that illustrates aspects of FIG. 2A;

FIG. 3A is a flow diagram that summarizes aspects of an instant-messaging capability within the conferencing application;

FIG. 3B is an exemplary screen view that illustrates aspects of FIG. 3A;

FIG. 4A is a flow diagram that summarizes aspects of a locator service within the conferencing application;

FIG. 4B is an exemplary screen view that illustrates aspects of FIG. 4A;

FIG. 5A is a flow diagram that summarizes aspects of a file-transfer capability within the conferencing application;

FIG. 5B is an exemplary screen view that illustrates aspects of FIG. 5A;

FIG. 6A is a flow diagram that summarizes aspects of a program-sharing capability within the conferencing application;

FIG. 6B is an exemplary screen view that illustrates aspects of FIG. 6A;

FIG. 7A is a flow diagram that summarizes aspects of a desktop-sharing capability within the conferencing application;

FIG. 7B is an exemplary screen view that illustrates aspects of FIG. 7A;

FIG. 8A is a flow diagram that summarizes aspects of a method for sequence optimization that may be used by the conferencing application;

FIG. 8B is a set of frames that illustrates aspects of FIG. 8A;

FIG. 9A is a flow diagram that summarizes aspects of a method for palette optimization that may be used by the conferencing application;

FIG. 9B is a set of frames that illustrates aspects of FIG. 9A;

FIG. 10A is a flow diagram that summarizes aspects of a method for frame-reduction optimization that may be used by the conferencing application;

FIG. 10B is a set of frames that illustrates aspects of FIG. 10A;

FIG. 11A is a flow diagram that summarizes aspects of a method for motion analysis and frame keying that may be used by the conferencing application;

FIG. 11B is a set of frames that illustrates aspects of FIG. 10A;

FIG. 12A is a flow diagram that summarizes aspects of a method for video-sequence transmission that may be used by the conferencing application;

FIG. 12B is a set of frames that illustrates aspects of FIG. 12A; and

FIG. 13 is a schematic representation of a computational unit that may be used to implement the conferencing application in embodiments of the invention.

### DETAILED DESCRIPTION OF THE INVENTION

1. Overview

Embodiments of the invention provide a multifunctional application that establishes a real-time communications and collaboration infrastructure. A plurality geographically distributed user computers are interfaced by the application to create a rapid work environment and establish integrated multimodal communications. In embodiments of the invention, the application may provide telephony and conferencing support to standard switched telephone lines through an analog modem; high-speed connectivity through an integrated-services digital network (“ISDN”) modem and virtual private network (“VPN”), with adapter support; telephony and conferencing support through a Private Branch Exchange (“PBX”); and point-to-point or multiuser conferencing support through a data network. Using these internet-protocol (“IP”) telephone features, collaborative connections may be established rapidly across private and/or public networks such as intranets and the Internet.

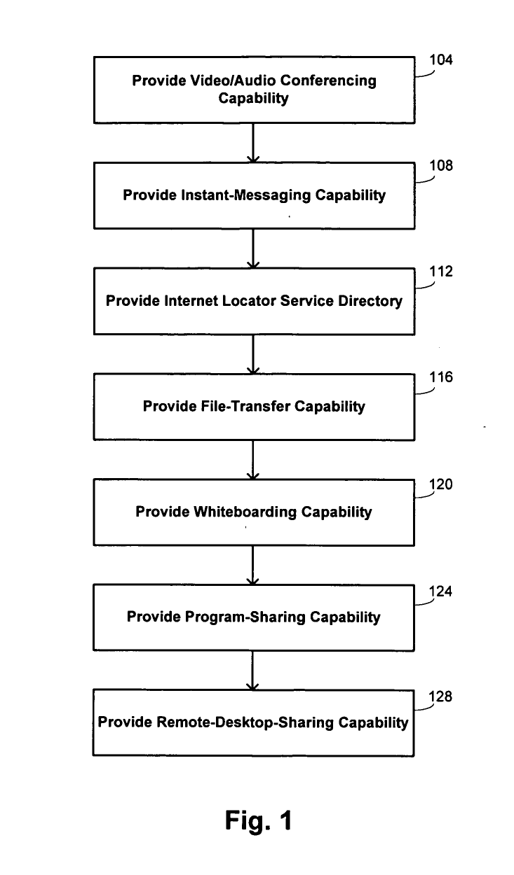

An overview of different types of functionality that may be provided with the application is illustrated with the flow diagram of FIG. 1. As with all flow diagrams provided herein, the identification of specific functionality within the diagram is not intended to be limiting; other functionality may be provided in addition in some embodiments or some functionality may be omitted in some embodiments. In addition, the ordering of blocks in the flow diagrams is not intended to be limiting since the corresponding functionality may be provided in a variety of different orders in different embodiments.

At block 104, audio and video conferencing capability is provided by using any of the supported environments to establish a connection among the geographically distributed user computers. For example, the connection may be established with a public switched telephone network (“PSTN”). Telephone connections made through a PSTN may have most calls transmitted digitally except while in a local loop between a particular telephone and a central switching office, where speech from a telephone is usually transmitted in analog format. Digital data from a computer is converted to analog by a modem, with data being converted back to its original form by a receiving modem. Basic telephony call support for modems is supported with the conferencing application using PSTN lines, such as dialing and call termination. In addition, computer-based support may be provided using any suitable command set known to those of skill in the art, such as the Hayes AT command set.

An ISDN may also be used in establishing the conferencing capability. An ISDN is a digital service provided by both regional and national telecommunications companies, typically by the same company that supports the PSTN. ISDN may provide greater data-transfer rates, in one embodiment being on the order of 128 kbps, and may establish connections more quickly than PSTN connections. Because ISDN is fully digital, the lengthy process of analog modems, which may take up to about a minute to establish a connection, is not required. ISDN may also provide a plurality of channels, each of which may support voice or digital communications, as contrasted with the single channel provided by PSTN. In addition to increasing data throughput, multiple channels eliminate the need for separate voice and data lines. The digital nature of ISDN also makes it less susceptible to static and noise when compared with analog transmissions, which generally dedicate at least some bandwidth to error correction and retransmission, permitting the ISDN connections to be dedicated substantially entirely to data transmission.

A PBX is a private telephone switching system connected to a common group of PSTN lines from one or more central switching offices to provide services to a plurality of devices. Some embodiments of the invention use such PBX arrangements in establishing a connection. For example, a telephony server may be used to provide an interface between the PBX and telephony-application program-interface (“TAPI”) enabled devices. A local-area-network (“LAN”) based server might have multiple connections with a PBX, for instance, with TAPI operations invoked at any associated client and forwarded over the LAN to the server. The server then uses third-party call control between the server and the PBX to implement the client's call-control requests. The server may be connected to a switch using a switch-to-host link. It is also possible for a PBX to be directly connected to the LAN on which the server and associated clients reside. Within these distributed configurations, different subconfigurations may also be used in different embodiments. For instance, personal telephony may be provided to each desktop with the service provider modeling the PBX line associated with the desktop device as a single-line device with one channel; each client computer would then have one line device available. Alternatively, each third-party station may be modeled as a separate-line device to allow applications to control calls on other stations, enabling the conferencing application to control calls on other stations.

IP telephony may be used in other embodiments to provide the connections, with a device being used to capture audio and/or video signal from a user, such information being compressed and sent to intended receivers over the LAN or a public network. At the receiving end, the signals are restored to their original form and played back for the recipient. IP telephony may be supported by a number of different protocols known to those of skill in the art, including the H.323 protocols promulgated by the International Telecommunications Union (“ITU”) and described in ITU Publication H.323, “Packet-based multimedia communications systems,” the entire disclosure of which is incorporated herein by reference.

At its most basic level, the H.323 protocol permits users to make point-to-point audio and video phone calls over the Internet. One implementation of this standard in embodiments of the invention also allows voice-only calls to be made to conventional telephones using IP-PSTN gateways, and audio-video calls to be made over the Internet. A call may be placed by the dialing user interface identifying called parties in any of multiple ways. Frequently called users may be added to speed-dial lists. After resolving a caller's identification to the IP address of the computer on which he is available, the dialer makes TAPI calls, which are routed to the H.323 telephony service provider (“TSP”). The service provider then initiates H.323 protocol exchanges to set up the call, with the media service provider associated with the H.323 TSP using audio and video resources available on the computer to connect the caller and party receiving the call in an audio and/or video conference. The conferencing application also includes a capability to listen for incoming H.323 IP telephony calls, to notify the user when such calls are detected, and to accept or reject the calls based on the user's choice.

In addition the H.323 protocol may incorporate support for placing calls from data networks to the switched circuit PSTN network and vice versa. Such a feature permits a long-distance portion of a connection to be carried on private or public data networks, with the call then being placed onto the switched voice network to bypass long-distance toll charges. For example, a user in a New York field office could call Denver, with the phone call going across a corporate network from the field office to the Denver office, where it would then be switched to a PSTN network to be completed as a local call. This technique may be used to carry audio signals in addition to data, resulting in a significant lowering of long-distance communications bills.

In some embodiments, the conferencing application may support pass-through firewalls based on simple network address translation. A simple proxy server makes and receives calls between computers separate by firewalls.

As indicated at block 108 of FIG. 1, the conferencing application may also provide instant-messaging capability. In one embodiment, a messaging engine may be provided that uses a TAPI subsystem for cross messaging, providing a common method for applications and devices to control the underlying communications network. Other functionality that may be provided by the conferencing application includes a locator service directory as indicated at block 112, a file-transfer capability as indicated at block 116, a whiteboarding capability as indicated at block 120, a program-sharing capability as indicated at block 124, and a remote-desktop-sharing capability as indicated at block 128. Each of these functionalities is described in further detail below. The whiteboarding capability may conveniently be used in embodiments of the invention to provide a shared whiteboard for all conference participants, permitting each of the participants to contribute to a collective display, importing features to the display, adding comments to the display, changing features in the display, and the like. The whiteboard is advantageously object-oriented (both vector and ASCII) in some embodiments, rather than pixel-oriented, enabling participants to manipulate the contents by clicking and dragging functions. In addition, a remote pointer or highlighting tool may be used to point out specific contents or sections of shared pages. Such a mechanism provides a productive way for the conference participants to work with documentary materials and to use graphical methods for conveying ideas as part of the conference. In addition to these functions, the conferencing application may include such convenient features as remote-control functionality, do-not-disturb features, automatic and manual silence-detection controls, dynamic network throttling, plug-and-play support and auto detection for voice and video hardware, and the like.

2.Conferencing Application

In a typical business-usage environment, the conferencing application may be used by employees to connect directly with each other via a local network to establish a whiteboard session to share drawings or other visual information in a conversation. In another application, the conferencing application may be used to place a conference voice call to several coworkers in different geographical locations to discuss the status of a project. All this may be achieved by placing calls through the computers with presence information that minimizes call cost, while application sharing and whiteboard functionality saves time and optimizing communications needs.

Gateway and gatekeeper functionality may be implemented by providing several usage fields, such as gatekeeper name, account name, and telephone number, in addition to fields for a proxy server and gateway-to-telephone/videoconferencing systems. Calls may be provided on a secure or nonsecure basis, with options for secure calls including data encryption, certificate authentication, and password protection. In some embodiments, audio and video options may be disabled in secure calls. One implementation may also provide a host for the conference with the ability to limit features that participants may enact. For example, meeting hosts may disable the right of anyone to begin any of the functionalities identified in blocks 108-128. Similarly, the implementation may permit hosts to make themselves the only participants who can invite or accept others into the meeting, enabling meeting names and passwords.

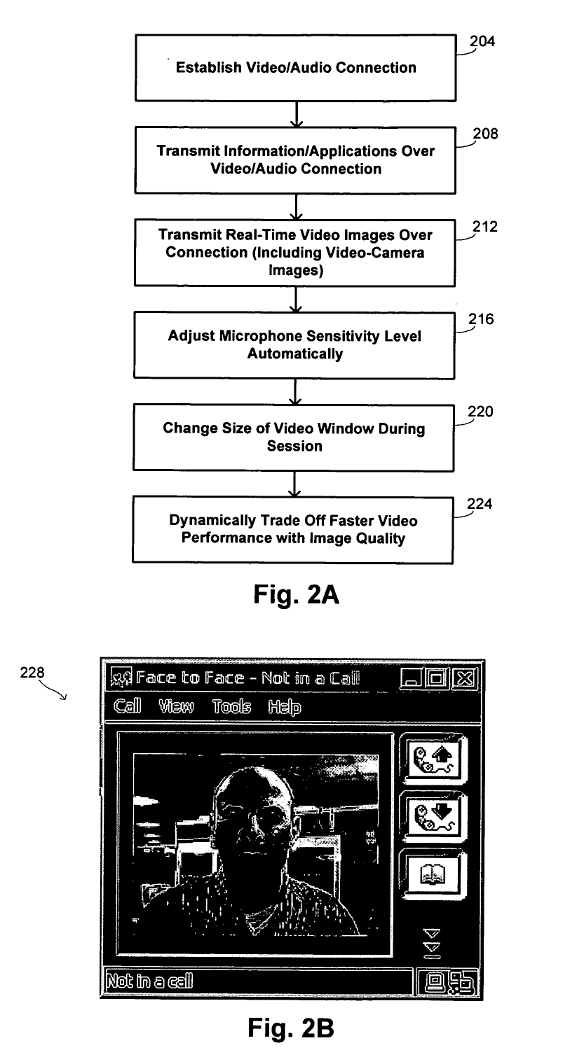

Further aspects of the video and audio conferencing functionalities are illustrated with the flow diagram of FIG. 2A and the exemplary screen view of FIG. 2B. The screen view 228 shows an example of a display that may provided and includes the video stream being generated. The video and/or audio connection is established at block 204 of FIG. 2A using one of the protocols described in detail above. With the connection established, information, ideas, applications, and the like may be shared at block 208 using the video and/or audio connections. Real-time video images may be sent over the connection as indicated at block 212; in some instances, such images may include instantly viewed items, such as hardware devices, displayed in front of a video collection lens. Options to provide playback control over video may be provided with such features as “pause,” “stop,” “fast forward,” and “rewind.” A sensitivity level of a microphone that collects audio data may advantageously be adjusted automatically at block 216 to ensure adequate audio levels for conference participants to hear each other. The conferencing application may permit video window sizes to be change during a session as indicated at block 220. The conferencing application may also include certain optimization techniques for dynamically trading off between faster video performance and better image quality as indicated generally at block 224. Further description of such techniques is provided below.

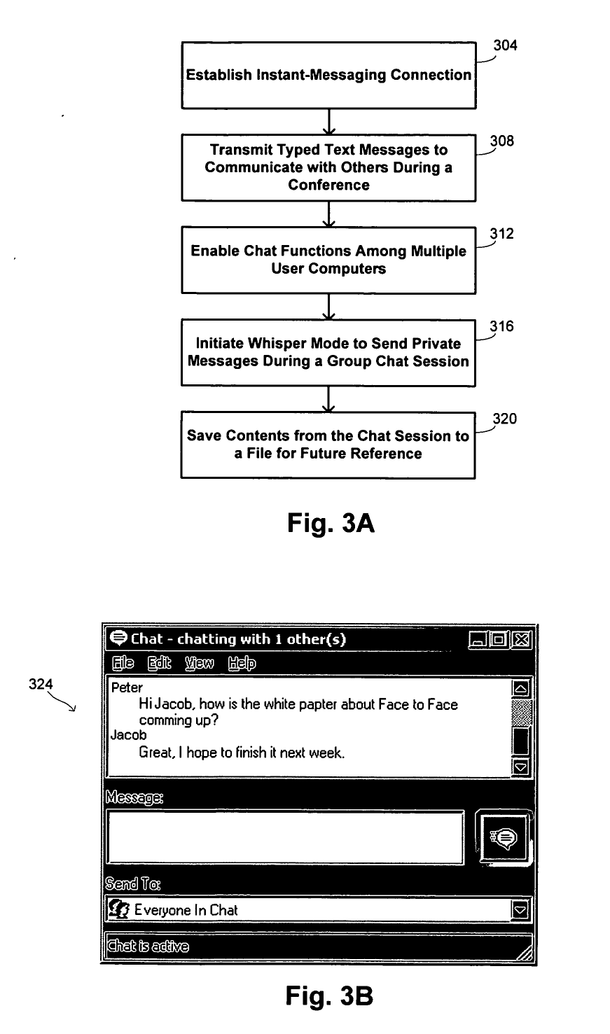

Further aspects of the instant-messaging functionalities are illustrated with the flow diagram of FIG. 3A and the exemplary screen view of FIG. 3B. The screen view 324 shows an example of a message that may be received as part of such an instant-messaging functionality and illustrates different fields for receiving and transmitting messages. This functionality is enabled by establishing an instant-messaging connection at block 304 of FIG. 3A. Text messages typed by one user may be transmitted to one or more other users at block 308. In instances where the messages are transmitted to all conference participants, as indicated at block 312, a “chat” functionality is implemented. In instances where a private message is transmitted to a subset of the conference participants, as indicated at block 316, a “whisper” functionality is implemented. The contents of the chat session may conveniently be recorded by the conferencing application at block 320 to provide a history file for future reference.

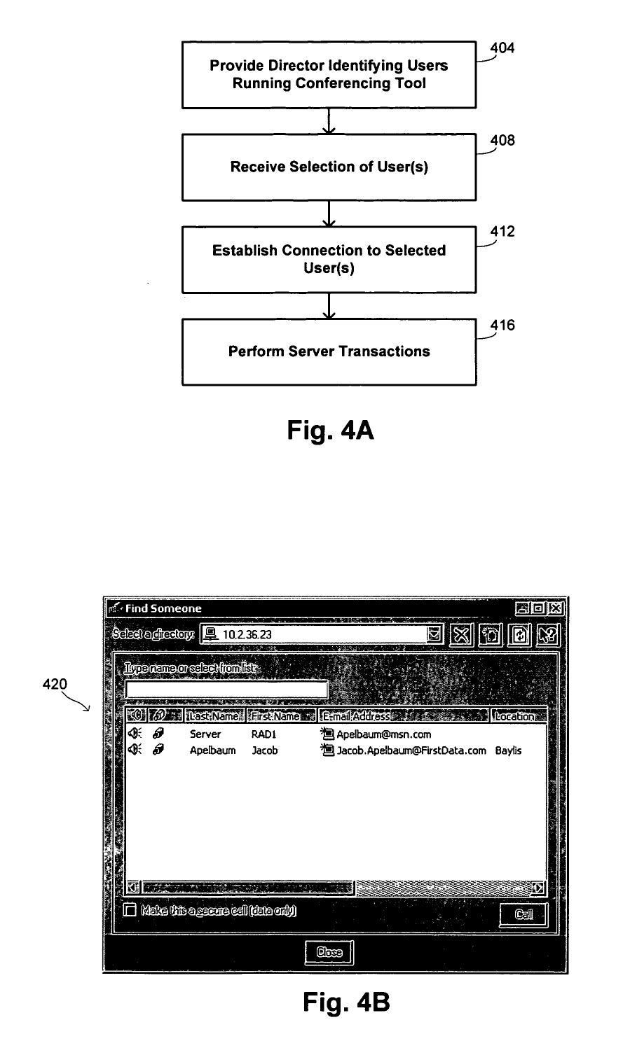

Functions of the locator service directory are illustrated with the flow diagram of FIG. 4A and corresponding exemplary screen view 420 of FIG. 4B. The locator service directory permits users to locate individuals connected to a network and thereby initiate a conferencing session that includes them. Such functionality is centered around a directory that may be configured to identify a list of users currently running the conferencing application. The directory is provided at block 404 of FIG. 4A, enabling a user to receive a selection of another user at block 408. A connection is established between the originating user and the selected user with the conferencing application at block 412, permitting conferencing functions between the two users to be executed. As indicated at block 416, a variety of server transactions may also be performed in some embodiments, such as enabling different directories to be view, creating directory listing of available users, and the like.

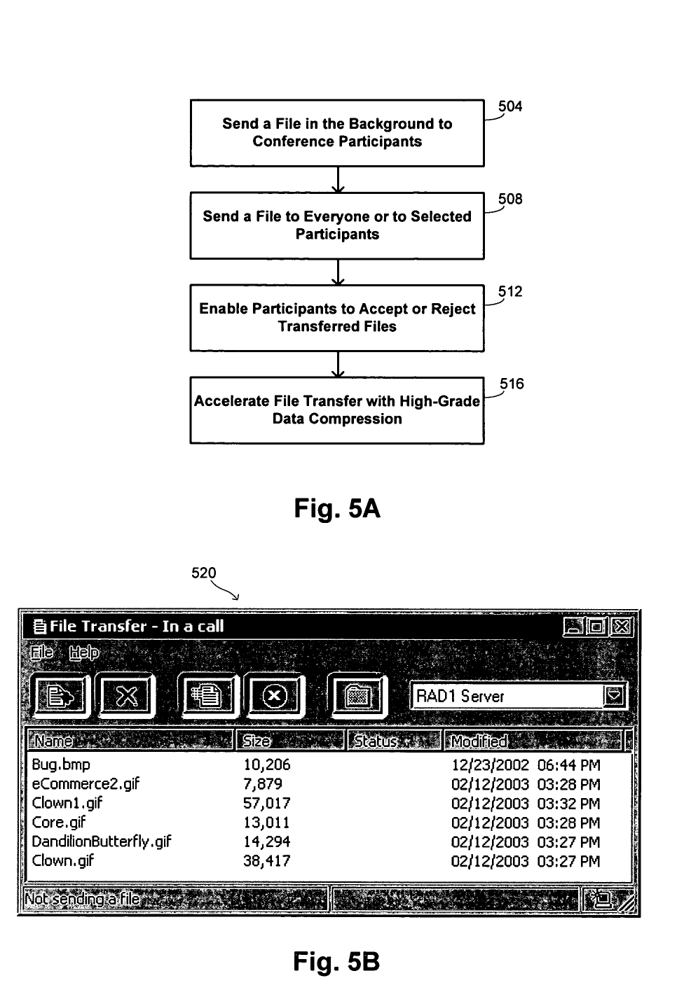

The file-transfer functionality is illustrated further with the flow diagram of FIG. 5A and corresponding exemplary screen view 520 of FIG. 5B. As indicated at block 504, this functionality permits a file to be sent in the background to conference participants. It is possible in different embodiments for the file to be sent to everyone included in a particular conference or only to selected participants, as indicated at block 508. Each participant may have the ability to accept or reject transferred files at block 512. Data-compression techniques may advantageously be used at block 516 to accelerate file transfers.

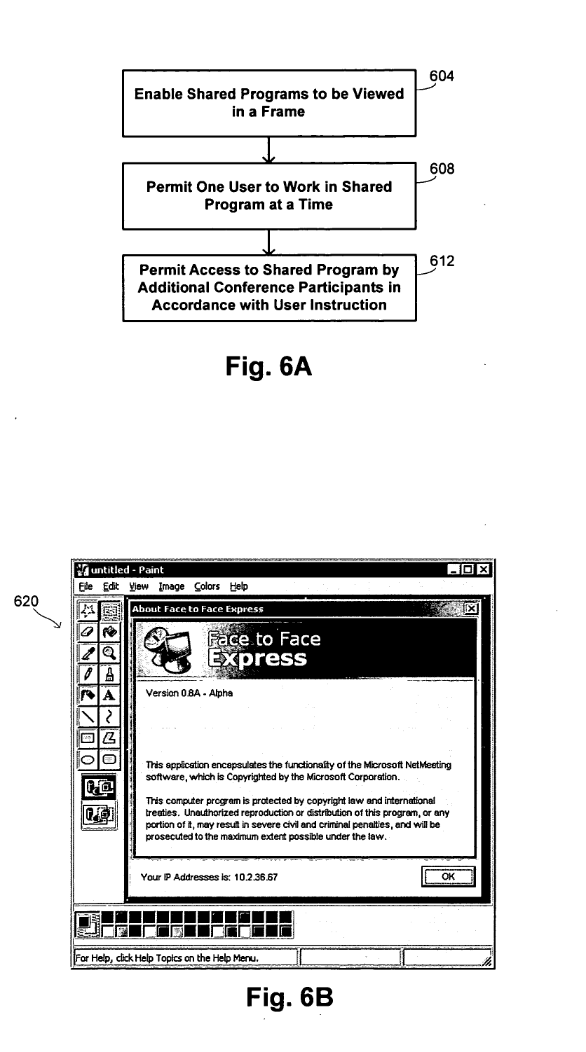

Further aspects of the file-sharing functionality are illustrated with the flow diagram of FIG. 6A and the corresponding exemplary screen view 620 of FIG. 6B. The file-sharing functionality generally enables share programs to be viewed in a frame, as indicated at block 604, a feature that makes it easy to distinguish between shared and local applications on each user's desktop. A user may thus share any program running on one computer with other participants in a conference. Participants may watch as the person sharing the program works, or the person sharing the program can allow program control to other meeting participants. Only the person sharing the program needs to have the program installed on his computer. The shared program frame may also be minimized so that the user may proceed with other functions if (s)he does not need to work in the current conference program. Similarly, this functionality makes it easy for users to switch between shared programs using the shared-program taskbar. Limitations may be imposed at block 608 by the conference initiator to permit only a single user to work in the shared program at any particular time. Access to the shared program by additional conference participants may be permitted in accordance with an instruction by the originating user at block 612.

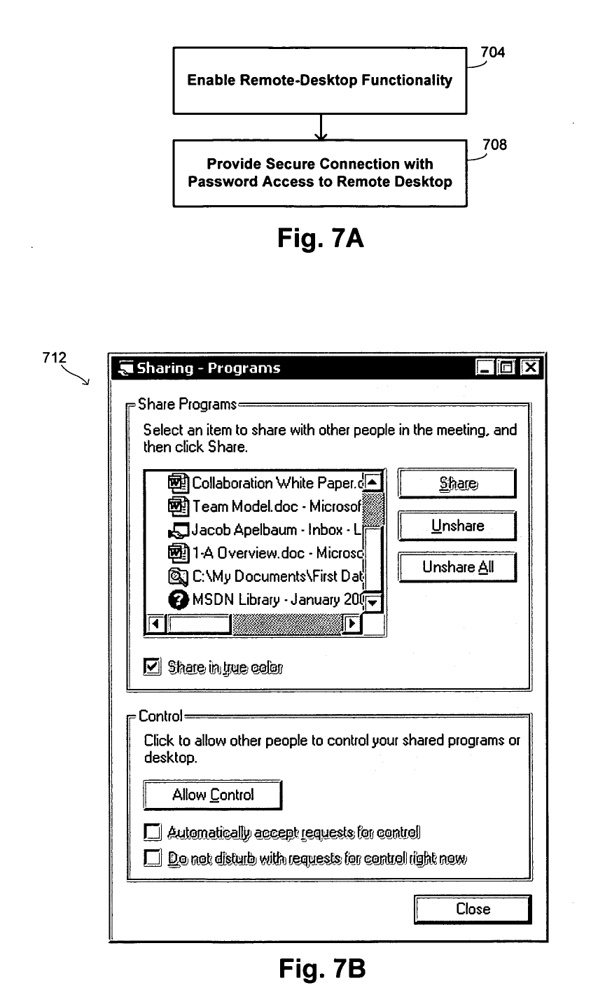

An illustration of the remote-desktop functionality is illustrated with the flow diagram of FIG. 7A and corresponding exemplary screen view 712 of FIG. 7B. After the remote-desktop functionality has been enabled at block 704, users have the ability to operate a user computer from a remote location, such as by operating an office computer from home or vice versa. A secure connection with a password may be used to access the remote desktop in such configurations at block 712.

The various implementations described above may include different security features. For example, encryption protocols may be used to encode data exchanged between shared programs, transferred files, instant messages, and whiteboard content. Users may be provided with the ability to specify whether all secure calls are encrypted and secure conferences may be held in which all data are encrypted. User-authentication protocols may be implemented to verify the identity of conference participants by requiring authentication certificates. For instance, a personal certificate issued by an external certifying authority or an intranet certificate server may be required of any or all of the conference participants. Password protections may also be implemented by the originating user required specification of the password by other conference participants to join the conference.

3. Optimization

Embodiments of the invention use a number of different optimization and bandwidth-management techniques. The average bandwidth use of audio, video, and data among the computers connected for a conference may be intelligently managed on a per-client basis. In addition, a built-in quality-of-service (“QoS”) functionality is advantageously included for network that do not currently provide RSVP and QoS. Such built-in QoS delivers advanced network throttling support while ensuring that conferencing sessions do not impact live network activity. This enables a smooth operation of the separate conferencing components and limits possible consumption of bandwidth resources on the network.

In one embodiment, audio, video, and data subsystems each create streams for network transmission at their own rates. The audio subsystem creates a stream at a fairly constant rate when speech is being sent. The video subsystem may produce a stream at a widely varying rate that depends on motion, quality, and size settings of the video image. The data subsystem may also produce a stream at a widely varying rate that depends on such factors as the use of file transfer, file size, the complexity of a whiteboard session, the complexity of the graphic and update information of shared programs, and the like. In a specific embodiment, the data stream traffic occurs over the secondary UDP protocol to minimize impact on main TCP arteries.

Bandwidth may be controlled by prioritizing the different streams, with one embodiment giving highest priority to the audio stream, followed by the data stream, and finally by the video stream. During a conference, the system continuously or periodically monitors bandwidth use to provide smooth operation of the applications. The bandwidth use of the audio stream is deducted from the available throughput. The data subsystem is queried for a current average size of its stream, with this value also being deducted from the available throughput. The video subsystem uses the remaining throughput to create a stream of corresponding average size. If no throughput remains, the video subsystem may operate at a minimal rate and may compete with the data subsystem to transmit over the network. In such an instance, performance may exhibit momentary degradation as flow-control mechanisms engage to decrease the transmission rate of the data subsystem. This might be manifest with clear-sounding audio, functional data conferencing, and with visually useful video quality, even at low bit rates.

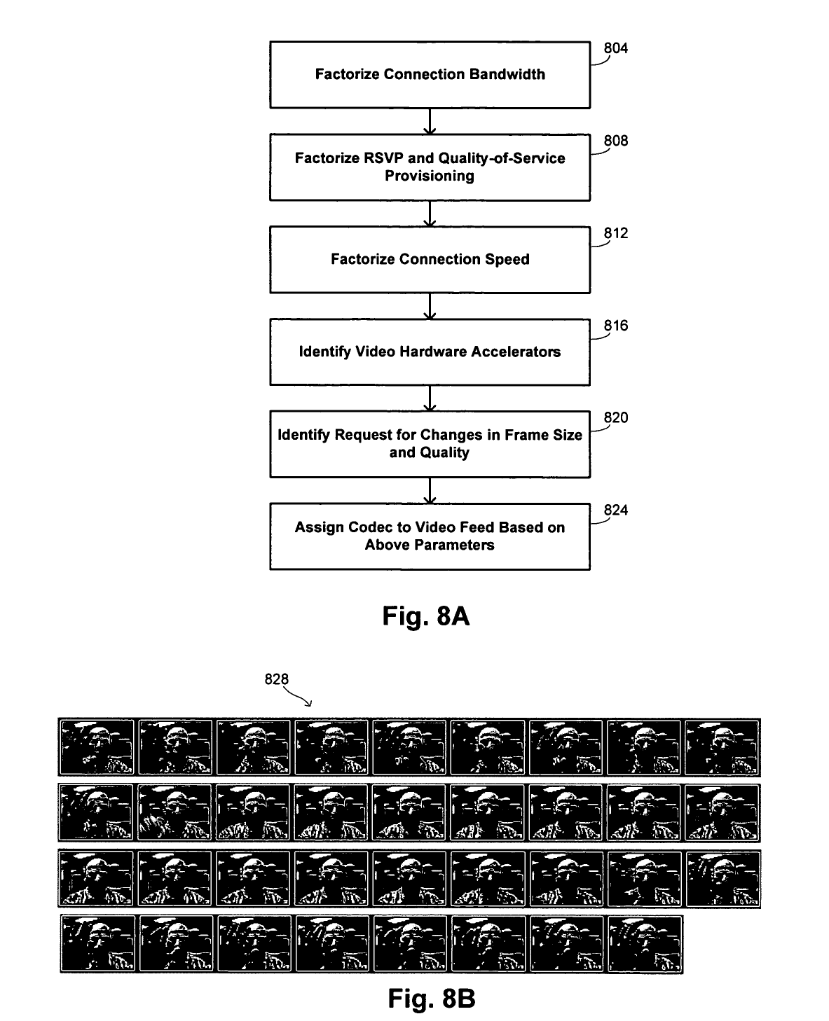

Various optimization techniques used in different embodiments are illustrated with FIGS. 8A-12B. These optimization techniques generally seek to reduce the amount of data transmitted during a conference, thereby maintaining high performance levels for the users. FIGS. 8A and 8B respectively provide a flow diagram and set of frame views to illustrate a sequence optimization method. The codec assignments to the video feed are based on a number of parameters. As indicated respectively at blocks 804, 808, and 812, various parameters may be factorized, including the connection bandwidth, the RSVP and QoS provisioning, and the connection speed. Video hardware accelerators are identified at block 816 and requests for changes in frame size and quality are identified at block 820. The resulting codec assignment is implemented at block 824.

Graphical information may be sent as orders in some embodiment. Instead of sending graphical updates as bitmap information exclusively, the conferencing application may instead send the information as the actual graphical commands used by a program to draw information on a user's screen. In addition, various caching techniques may be used as part of the sequence optimization. Data that comprises a graphical object may be sent only once, with the object then stored in a cache. The next time the object is to be transmitted, a cache identifier may be transmitted instead of the actual graphical data. Maintenance of a queue of outgoing data may also minimize the impact on a local user when a program calls graphical functions faster than the conferencing application can transmit the graphics to remote conference participants. Graphical commands are queued as they are drawn to the screen, and the graphical functions are immediately returned so that the program can continue. An asynchronous process subsequently transmits the graphical command. Changes in the outgoing data queue may also be monitored. When the queue becomes too large, the conferencing application may collect information based on the area of the screen affected by the graphical orders rather than the orders themselves. Subsequently, the necessary information is transmitted collectively.

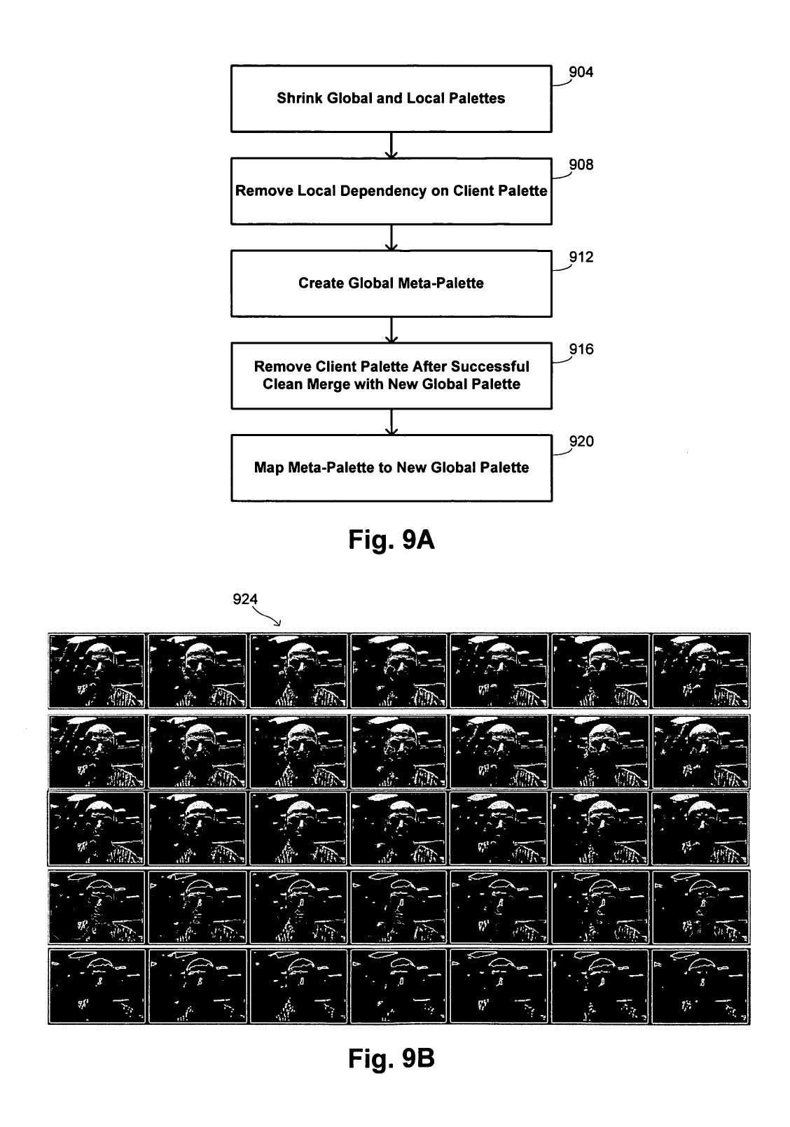

A method for color-palette optimization is illustrated with the flow diagram of FIG. 9A and corresponding set of frames 924 of FIG. 9B. This method reduces the color depth of insignificant pixels in order to reduce the overall size of a transmitted image by transmitting only pixels relevant to the image integrity. At block 904, global and local palettes are shrunk to reduce the color depth, and the local dependency on the client palette is removed. A global meta-palette is created at block 912, permitting the client palette to be removed at block 916 after a successful merge with a new global palette. The meta-palette is mapped to the new global palette at block 920.

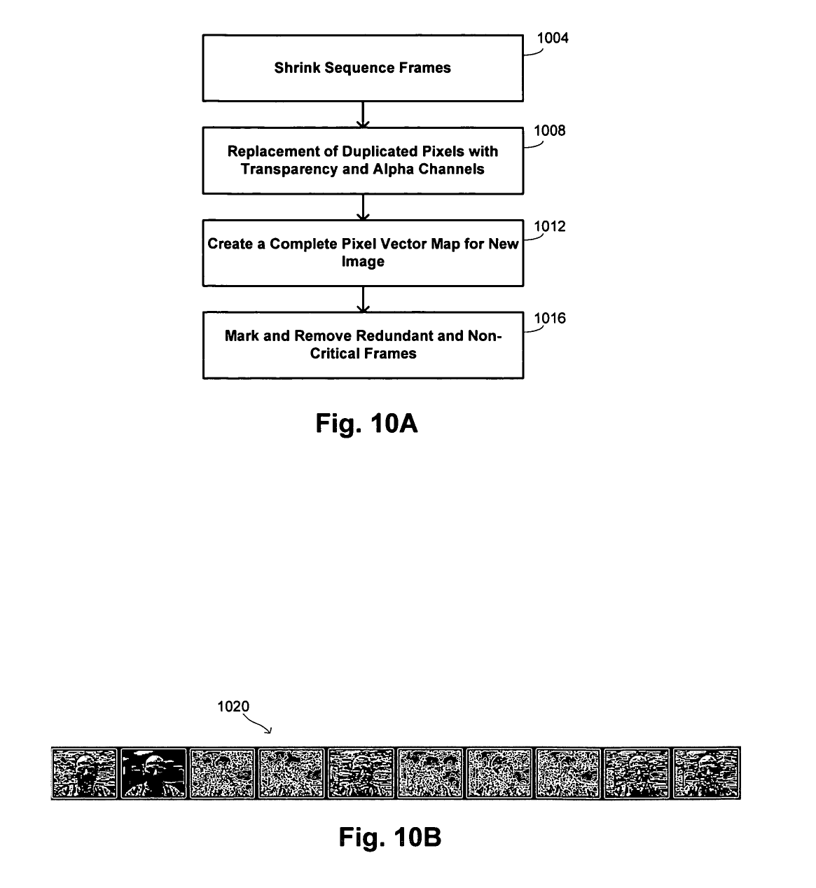

A frame-reduction method may also be used, as illustrated with the flow diagram of Fig. 10A and the corresponding set of frames 1020 of FIG. 10B. The sequence frames are shrunk at block 1004, such as to the smallest possible rectangle. Duplicated pixels are replaced with transparency and alpha channels at block 1008, permitting creation of a complete pixel vector map for the new image at block 1012. Redundant and noncritical frames are marked and removed at block 1016. This method permits the conferencing application to check, prior to adding a new piece of graphic output to the outgoing data queue, for existing output that the new graphic output might obscure. Existing graphic output in the queue that will be obscured by the new graphic output is discarded and the obscured output never gets transmitted. This method also permits the conferencing application to analyze various image frames for redundant information, stripping that redundant information from the transmission.

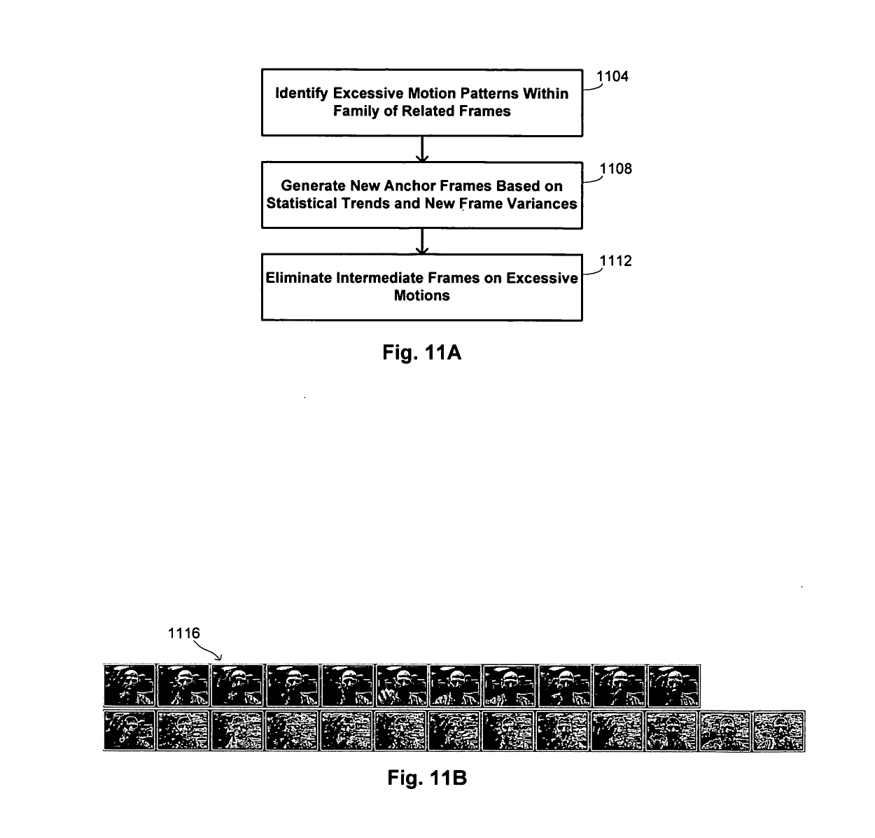

A method for motion analysis and frame keying is illustrated with the flow diagram of FIG. 11A and the corresponding set of frames 1116 shown in FIG. 11B. Excessive motion patterns within a family of related frames are identified at block 1104 of FIG. 11A, permitting new anchor frames to be generated at block 1108, based on statistical trends and new frame variances. The intermediate frames on excessive motions may be eliminated at block 1112 so that the size of the transmission is correspondingly reduced.

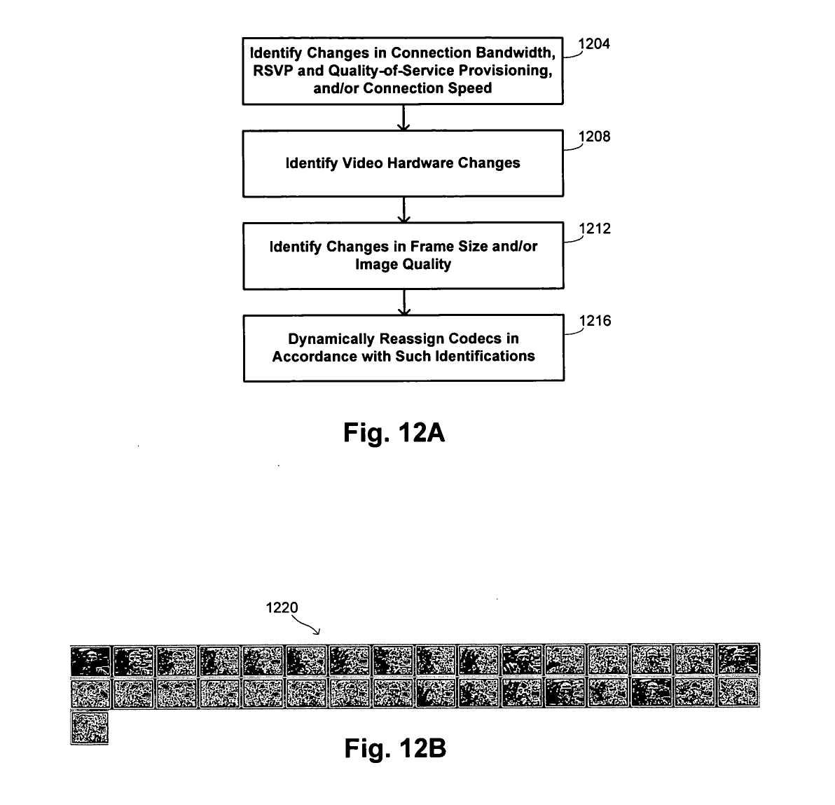

A method for optimizing video-sequence transmission is illustrated with the flow diagram of FIG. 12A and the corresponding set of frames 1220 provided in FIG. 12B. This method is related to the method described in connection with FIGS. 8A and 8B and results in a dynamic reassignment of codecs based on certain identified parameters. For example, at block 1204, changes in connection bandwidth, RSVP and QoS provisioning, and/or connection speed are identified. At block 1208, video hardware changes are identified. At block 1212, changes in frame size and/or in image quality are identified. Based on these identifications, the dynamic reassignment of codecs is implemented at block 1216.

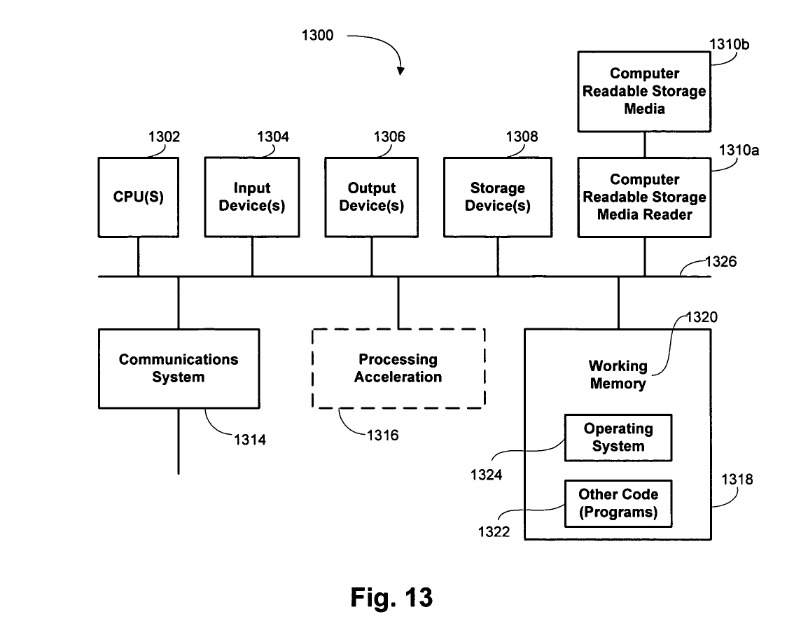

The conferencing application described herein may be embodied on a computational device such as illustrated schematically in FIG. 13, which broadly illustrates how individual system elements may be implemented in a separated or more integrated manner. The computational device 1300 is shown comprised of hardware elements that are electrically coupled via bus 1326. The hardware elements include a processor 1302, an input device 1304, an output device 1306, a storage device 1308, a computer-readable storage media reader 1310a, a communications system 1314, a processing acceleration unit 1316 such as a DSP or special-purpose processor, and a memory 1318. The computer-readable storage media reader 1310a is further connected to a computer-readable storage medium 1310b, the combination comprehensively representing remote, local, fixed, and/or removable storage devices plus storage media for temporarily and/or more permanently containing computer-readable information. The communications system 1314 may comprise a wired, wireless, modem, and/or other type of interfacing connection and permits data to be exchanged with external devices.

The computational device 5300 also comprises software elements, shown as being currently located within working memory 1320, including an operating system 1324 and other code 1322, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of managing bandwidth in transmitting multimedia over a network, the method comprising:
creating an audio stream for transmission of audio information over the network at an audio rate;
creating a video stream for transmission of video information over the network at a video rate;
creating a data stream for transmission of data information over the network at a data rate, wherein each of the audio rate, the video rate, and the data rate is determined independently of others of the audio rate, the video rate, and the data rate; and
transmitting the audio stream, the video stream, and the data stream collectively over the network and respectively at the audio rate, the video rate, and the data rate according to a priority hierarchy that gives precedence of the audio stream over the video stream and data stream, and gives precedence of the data stream over the video stream.

2. The method recited in claim 1 further comprising assigning a bandwidth for the video stream and data stream substantially equal to a total bandwidth for a connection with the network less a bandwidth used by the audio stream corresponding to the audio rate.

3. The method recited in claim 2 further comprising:
determining a current average size of the data stream;
assigning a bandwidth for the video stream equal to the bandwidth for the video stream and data stream less the current average size of the data stream; and
determining the video rate from the assigned bandwidth for the video stream.

4. The method recited in claim 3 wherein the assigned bandwidth for the video stream is approximately zero, the method further comprising having the data stream and the video stream compete for transmission over the network.

5. The method recited in claim 3 further comprising receiving a specification of a network-connection type to define the total bandwidth.

6. The method recited in claim 5 wherein the network-connection type is selected from the group consisting of a 28.8 kbps modem connection, a 56.6 kbps modem connection, a cable connection, a digital subscriber line (“DSL”), an integrated services digital network (“ISDN”) connection, a satellite link, and a local-area-network (“LAN”) connection.

7. The method recited in claim 1 wherein the data stream comprises whiteboard information.

8. The method recited in claim 1 wherein the data stream comprises instant-messaging information.

9. The method recited in claim 1 wherein the data stream comprises program-sharing information.

10. A system for transmitting multimedia over a network, the system comprising:
an audio subsystem configured to create an audio stream for transmission of audio information over the network at an audio rate;
a video subsystem configured to create a video stream for transmission of video information over the network at a video rate;
a data subsystem configured to create a data stream form transmission of data information over the network at a data rate, wherein each of the audio rate, the video rate, and the data rate is determined independently of others of the audio rate, the video rate, and the data rate; and
a communications system interfaced with the audio subsystem, the video subsystem, and the data subsystem and configured to transmit the audio stream, the video stream, and the data stream collectively over the network and respectively at the audio rate, the video rate, and the data rate according to a priority hierarchy that gives precedence of the audio stream over the video stream and data stream, and gives precedence of the data stream over the video stream.

11. The system recited in claim 10 further comprising a controller in communication with the audio subsystem, the video subsystem, and the data systems and configured to determine the audio rate, the video rate, and the data rate, the controller having instructions to assign a bandwidth for the video stream and data stream substantially equal to a total bandwidth for a connection with the network less a bandwidth used by the audio stream corresponding to the audio rate.

12. The system recited in claim 11 wherein the controller further has:
instructions to determine a current average size of the data stream;
instructions to assign a bandwidth for the video stream equal to the bandwidth for the video stream and data stream less the current average size of the data stream; and
instructions to determine the video rate from the assigned bandwidth for the video stream.

13. The system recited in claim 12 wherein:
the assigned bandwidth for the video stream is approximately zero; and
the controller further has instructions to have the data stream and the video stream compete for transmission over the network.

14. The system recited in claim 12 wherein the controller further has instructions to receive a specification of a network-connection type to define the total bandwidth.

15. The system recited in claim 14 wherein the network-connection type is selected from the group consisting of a 28.8 kbps modem connection, a 56.6 kbps modem connection, a cable connection, a digital subscriber line (“DSL”), an integrated services digital network (“ISDN”) connection, a satellite link, and a local-area-network (“LAN”) connection.

16. The system recited in claim 10 wherein the data stream comprises whiteboarding information.

17. The system recited in claim 10 wherein the data stream comprises instant-messaging information.

18. The system recited in claim 10 wherein the data stream comprises program-sharing information.
